(19) United States
(12) Patent Application Publication
(10) Pub. No.: US 2020/0294071 A1
(43) Pub. Date: Sep. 17, 2020

(54) DETERMINING USER INTENTS RELATED TO WEBSITES BASED ON SITE SEARCH USER BEHAVIOR

(71) Applicant: Cludo, Inc., Minneapolis, MN (US)

(72) Inventors: Corey Christensen, Minneapolis, MN (US); Niels Ebbe Ebbesen, Holte (DK)

(21) Appl. No.: 16/817,473

(22) Filed: Mar. 12, 2020

Related U.S. Application Data
(60) Provisional application No. 62/817,339, filed on Mar. 12, 2019.

(51) Int. Cl. G06Q 30/02; G06F 16/9535; G06F 16/2457; G06N 5/04

(52) U.S. Cl. CPC G06Q 30/0204; G06F 16/9535; G06F 3/0482; G06Q 30/0201; G06N 5/04; G06F 16/24578

(57) ABSTRACT

In one implementation, a method for determining user intents for a website includes accessing, by an analytics system, site search data for the website. The website can include a plurality of webpages and the site search data can include (i) site search queries for the website and (ii) site search user behavior that identifies particular webpages from among search results for the site search queries. The method can further include determining query-page scores for each pair of the site search queries and the plurality of webpages based on the site search data. The method can additionally include generating combined scores for the site search queries based on the query-page scores. The method can also include identifying groupings of the site search queries based on the combined scores, determining user intents for the website based on the groupings of the site search queries, and outputting the determined user intents.

### CLAIM OF PRIORITY

This application claims priority under 35 USC § 119(e) to U.S. Patent Application Ser. No. 62/817,339, filed on Mar. 12, 2019, the entire contents of which are hereby incorporated by reference.

### TECHNICAL FIELD

This document generally relates to determining user intents related to websites based on site search user behavior, which includes users submitting search queries for content on a website, receiving site search results, and selecting specific pages of the website from the results.

### BACKGROUND

Websites are a popular way to convey information and content to users. A website is generally understood to be a collection of related webpages (e.g., static webpages, dynamic webpages) that are accessible from one or more common domains (e.g., example.com), which may be hosted across one or more web servers. Some websites may include corporate websites for internal and/or external user, blogs, online stores, and other social media outlets. To assist users in identifying relevant content, websites often include site search functionality that permits users to submit search queries for content hosted on the website, and to receive results of pages (or other portions) of the website that may contain the content the user is attempting to locate. For example, a user visiting an educational website that enters the search query “math” can be provided with search results for different pages of the educational website that have content related to “math.” Such search results can include features that permit the user to select one or more of the search results, such as providing the search results with links to corresponding web pages that the user can select/click in order to navigate to the web pages.

Analytics systems have been developed to assist website owners and managers to better understand user behavior on websites, such as which portions of the websites users visit the most frequently, which portions they do not, and other relevant details. Analytics systems can involve, for example, code that tracks various user behavior across web pages that make up a website, such as which links are selected by users, how long users spend on each page, which portions of the pages users view, which pages users navigate between, which search queries users submit, which search results users select, how users navigate to the website, what sort of devices users access the website from, and other relevant user behavior information. Analytics systems have been used by website owners and managers to better understand how a website is used, which can help website owners and managers improve upon the website so that its organization and content is more relevant to its user base.

### SUMMARY

The present disclosure describes systems, devices, techniques, and computer program products for determining user intents that are relevant to websites based on user behavior within the context of the websites, such as user behavior for site searches on websites. User intents for a website include, for example, topics and themes that users are intending to locate on a website—the content and information that users intend to access when visiting a website. User intents identified for websites can include groupings of contextually-related site search queries into broader themes and topics. Understanding and identifying user intents for a website can be beneficial to a website owner and manager in a variety of ways, such as helping them better organize, present, and provide content on webpages so that users are able to more readily access relevant content when visiting a website.

Sources for identifying user intents, such as user surveys/feedback and website analytics, can present limited, incomplete, or far too detailed of a look at true user intents that drive website visits. For example, the majority of users who visit a website may not be willing to fill out a user surveys and to otherwise provide feedback on the website's ability to populate relevant content to the user's website visit. As a result, such sources of user intent information can be incomplete and present feedback from only a small portion of the user base, which may cause any inferences from such information to be inaccurate. In another example, website analytics information can provide too much information that is too detailed to glean anything actionable or relevant to a website owner/manager. For instance, a count of page visits for different pages on the website may be helpful in identifying which pages the users appear to have visited the most, but it may not provide any indication of why the users visited those particular pages or what content on those pages was found to be particularly relevant to cause the user to visit those pages.

The disclosed technology can provide comprehensive inferences of user intents based on user behavior on websites through site searches. Such comprehensive user intents can be generated dynamically based on empirical data demonstrating what users are actually visiting a website for, and without having to rely on direct user feedback (e.g., surveys) or human review/classification of data (e.g., person sifting through data to generate groupings). Accordingly, such resulting user intent determinations can be more accurate and representative of actual intents of users when visiting websites. Additionally, user intents can be determined using webpages (or other identifiable/navigable web resources that are part of a website) of websites as contextual anchors for determining user intents, which can generate intents that are based on the contextual content of websites and the contextual user behavior data for users accessing that content. Furthermore, user intents can be distilled down to category/topic headings that are useful for website owners/managers to understand and act upon user intents instead of being overwhelmed with voluminous and sometimes duplicative data, like query site search logs, which are unhelpful for gleaning actionable information on user intents relative to websites.

The disclosed technology can generate user intents using any of a variety of techniques. For example, user intents can be determined for a website by evaluating site search query data for site search queries submitted for the website (and corresponding user behavior in response to receiving site search results) and grouping search queries that appear in similar contexts into buckets (e.g., topics, categories, groups) that represent different user intents (e.g., interests, goals, behavior). Similar contexts can include, for example, webpages that were selected from a search query results for site search queries for a website. For instance, as a simplistic illustrative example, site search queries that caused users to select the same pages (or portions thereof) from the search results for those queries may be grouped together in the same bucket, and can be used to generate a user intent for that bucket. Additional and/or different factors can be used to determine query groupings and user intents resulting from those groupings, as described below in greater detail.

Improved analytics can be provided in a variety of ways. For example, user search behavior data can be aggregated and standardized (e.g., remove punctuation and stop words). User-defined typos, synonyms, and/or contextual/descriptive words can be incorporated into the data to further refine the site search query data. The site search data can be evaluated to group queries using any of a variety of techniques, such as techniques to weigh the relative significance of site search query to webpage (or other website resource) associations and techniques to group such weightings. For instance, techniques such as term frequency-inverse document frequency (TF-IDF) and cosine similarity can be used, as well as other combinations of weighting and grouping techniques. Initial groupings of search queries can be evaluate and some search queries can be removed based on whether the search queries satisfy one or more confidence thresholds, such as customer-specific confidence threshold. A search query that does not sufficiently relate to a bucket that the query is initially placed in (e.g., the search query does not meet the one or more confidence threshold values) can be moved to a catch-all “other” intent bucket. One or more search queries in the “other” bucket can be analyzed again and, in some instances, re-classified into buckets with which those queries are most likely associated with. The search queries in the “other” bucket can be better associated with different intent buckets. Search queries can be grouped more accurately and with less error, resulting in less use of the “other” bucket and re-classification techniques.

As more user search queries are analyzed and placed into intent buckets, the systems described herein can become more robust and can be dynamically updated based on user behavior data over time. For example, intent buckets can be modified over time to represent changing trends in user search queries and user behavior with regard to a website, and to capture changes in the content on the website over time. As the buckets become more robust to meet more specific user intents, the system can more accurately provide the website administrators with precise suggestions to modify the websites to better meet user intents and interests.

In one implementation, a method for determining user intents for a website includes accessing, by an analytics system, site search data for the website. The website can include a plurality of webpages and the site search data can include (i) site search queries transmitted by client devices to a site search engine for the website and (ii) site search user behavior that identifies particular webpages from among the plurality of webpages selected on the client devices from among search results for the site search queries. The method can further include determining, by the analytics system, query-page scores for each pair of the site search queries and the plurality of webpages based on the site search data, wherein each of the query-page scores identifies how well a webpage represents a user intent for a site search query. The method can additionally include generating, by the analytics system, combined scores for the site search queries based on the query-page scores, wherein each of the combined scores for a site search query combines the query-page scores for that site search query. The method can also include identifying groupings of the site search queries based on the combined scores, determining user intents for the website based on the groupings of the site search queries, and outputting the determined user intents.

Such a method can optionally include one or more of the following features. The query-page scores can include term frequency inverse document frequency (TF-IDF) scores that are determined for each pair of the site search queries and the plurality of webpages based on the site search data. The site search data can include a number of selections for the plurality of webpages for the site search queries. For each of the query-page pairs that pairs a particular site search query and a particular webpage, the TF-IDF score can be determined based on (i) a first number of selections of the particular webpage for the particular site search query, (ii) a second number of selections of the particular webpage across all of the site search queries, (iii) a third number of selections of all of the plurality of webpages across all of the site search queries, and (iv) a fourth number of selections of all of the plurality of webpages for the particular site search query. For each of the query-page pairs that pairs a particular site search query and a particular webpage, the TF-IDF score can be determined from a term frequency score and an inverse document frequency score. The term frequency score can be determined by dividing the first number of selections by the second number of selections. The inverse document frequency score can be determined by taking a log of the third number of selections divided by the fourth number of selections. The TF-IDF score can be a product of the term frequency score and the inverse document frequency score.

The combined scores for the site search queries can include multi-dimensional vectors for each of the site search queries, where each dimension corresponds to one of the plurality of webpages for the website. The multi-dimensional vectors can map the site search queries into a multi-dimensional space that represents a context provided by the plurality of webpages for the website, with the positioning of the site search queries in the multi-dimensional space representing associations between the site search queries and the context provided by the plurality of webpages for the website. The groupings can be identified based on the proximity of the site search queries to each other within the multi-dimensional space using the multi-dimensional vectors representing the site search queries. The proximity can be determined using cosine similarity determinations among pairs of the site search queries. The proximity can be determined using distance determinations among pairs of the site search queries. The groupings can be identified based on sets of the site search queries being determined to have at least a threshold level of proximity to each other within the multi-dimensional space.

Determining the user intents can include determining a confidence value for the groupings, and identifying the groupings that have at least a threshold confidence value as user intents for the website. The confidence value can be determined based on how closely related the site search queries within the groupings are to each other. The combined scores for the site search queries can include multi-dimensional vectors for each of the site search queries. Each dimension can correspond to one of the plurality of webpages for the website. The multi-dimensional vectors map the site search queries into a multi-dimensional space can represent a context provided by the plurality of webpages for the website, with the positioning of the site search queries in the multi-dimensional space representing associations between the site search queries and the context provided by the plurality of webpages for the website. The closeness of relationships between the site search queries can be determined based on distances among the multi-dimensional vectors to each other within the multi-dimensional space. The confidence value can be determined based on a number of site search queries for the groupings relative to an overall number of site search queries for the website. The threshold confidence value can be determined based on an overall number of site search queries for the website.

Outputting the user intents can include outputting site search analytics for the website that are grouped based on the user intents. The site search analytics can include one or more of the following: a number of search queries for the user intents, a click-through-rate for the user intents, and a trending identifier for the user intents. Outputting the site search analytics can include identifying one or more ineffective user intents that comprise user intents with at least a threshold number of search queries and click-through-rates below a threshold click-through-rate, and outputting one or more graphical elements in a user interface identifying the ineffective user intents. Outputting the site search analytics can include identifying one or more trending user intents that comprise user intents with at least a threshold increase in a number of search queries over a period of time, and outputting one or more graphical elements in a user interface identifying the trending user intents. Outputting the site search analytics can include identifying one or more top user intents that comprise user intents with at least a threshold ranking among the user intents based on or more of: a number of searches, a number of clicks, and a click-through rate, and outputting one or more graphical elements in a user interface identifying the top user intents.

The subject matter described in this specification can be implemented in particular implementations, so as to realize one or more of the following advantages. For example, this technology can assist website administrators in updating websites to include content that corresponds trending topics, intents, content, and/or information that users want to access when the users search on the websites. In another example, the disclosed technology provides improved website analytics so that website administrators can improve/modify websites to provide content, information, and/or products that users intend to receive when the users input search queries into the website.

In another example, by creating buckets of user intent, based on current user behavior data, historic user behavior data, and topics that are generated based on content from each webpage of a website, and associating user search queries with each of the buckets, the disclosed technology can provide improved methods to condense user search queries into useful information so that the website administrator can identify one or more categories of content, products, and/or information that users are most interested in. For instance, in an example case study a website received 30,634,089 total site search queries over a period of 12 months. These site search queries included 21,510 unique search terms. Using the technology described throughout this document, the set of site search queries for this website were condensed down to 28 unique intents for the website. So instead of this website owner and manager having to sift through more than 21,000 unique search terms to understand the website's end users, they were able to look at just 28 major intents to gain a better and more comprehensive understanding of the website's end users. This is a reduction of 99.87% in the quantity of data, all without loss of valuable information.

In another example, website administrators can use intent groupings to modify the website to reflect those categories and better meet user goals. Additionally, the disclosed technology can provide simpler and more seamless analytics to website administrators to more intuitively learn what user intents are trending at the moment (e.g., what the most common/popular user search queries are, what content users are viewing the most). The disclosed technology can also provide suggestions about how the website administrators can improve the websites to include and/or better meet users' intents and interests.

In another example, user intents can be evaluated over periods of time to identify trends over time and to predict future website use. For example, seasonality of user intents can be identified and can be used to help website owners/managers plan for content changes and updates, such as planning to refresh website content and for releasing/posting specific types of content. Intents can be used to help anticipate changes in user interests over time, and to adapt website content proactively to meet user demand.

The details of one or more implementations of the subject matter of this specification are set forth in the set forth in the Detailed Description, the Claims, and the accompanying drawings. Other features, aspects, and advantages of the subject matter will become apparent from the Detailed Description, the Claims, and the accompanying drawings.

### BRIEF DESCRIPTION OF DRAWINGS

FIG. 1 is an example system for determining user intents on a website.

FIGS. 2A-C are flowcharts of example techniques for determining user intents for a website based on site search user behavior data.

FIGS. 3A-C provide a simple illustrative example of determining intent groupings based on site search user behavior using the techniques described throughout this document.

FIGS. 4A-C present different system arrangements of the analytics system being implemented with regard to a web server system and a site search system.

FIGS. 5A-B are example user interfaces presented to a website administrator.

### DETAILED DESCRIPTION

The present disclosure describes systems, methods, techniques, and devices for generating intents for websites based, at least in part, on site search user behavior for the websites. As described throughout this document, site search user behavior include includes actions (or the absence thereof) that are taken by users during site search sessions for websites. Site search pertains to searching for relevant content on a website through the use of site search queries, which are search queries (e.g., textual queries, voice-based queries, image-based queries) submitted to a site search engine for a website. Relevant information identified from site search queries can be returned in site search results, which are presented to the user. Site search results can include, for example, lists of webpages that are part of a website being searched and that were identified by the site search engine for the website as being relevant to the site search query. The site search results can include, for example, links or other elements that a user can select to navigate to and view the associated webpage in the results. Site search behavior can include information detailing site search queries submitted and subsequent actions that users take in response to receiving results for those queries, such as selecting results to webpages presented in the results.

Using the site search user behavior for websites, intents can be organically and dynamically generated for websites by using webpages (or other website resources that are provided in search results) to provide contextual content to the user behavior. For example, an online store has individual webpages wherein each webpage presents differently categorized clothing items. One webpage can be for tops, another for jeans, another for work pants, and another for skirts. For illustrative purposes, assume that the user search behavior for this example webpage includes users frequently selecting the jeans webpage from site search results for the site search query “jeans,” and users more frequently selecting the webpage for jeans than the work pants website from site search results for the site search query for “blue pants.” With the described technology, this example site search user behavior can be analyzed to group the site search into buckets based on contextual clues, which in this example include the webpages and the corresponding user behavior selecting particular webpages for site search queries. Using this example scenario, the analytics systems described throughout this document can determine that the query “blue pants” fits into the intent bucket for jeans rather than work pants based on the contextual site search user behavior. As a result, a “jeans” intent can be generated that includes the “jeans” site search query and the “blue pants” site search query.

Determined intent for websites can be used in a variety of ways, such as providing analytics that group site search data (and/or other website data), improving site search engines and the results that they provide to users (e.g., if users search “blue pants” after it is grouped into the “jeans” intent, the users will receive search results for the jeans webpage), and/or other uses. For example, intents can be used to determine what website content is trending, what website content users search for the most, and how many and which search queries direct the users to the website content they intend to see, even if the users use non-generic, non-synonymous words in their site search queries. In another example, intents can be used to reduce the complexity of site search data for website owners/managers without any loss of information (e.g., example case study reducing 21,510 unique search terms down to 28 unique intents for a website without loss of information). In another example, intents can be used to identify areas of content that are lacking, such as by identifying queries within an intent have low click-through rates. In another example, intents can be used to help website owners/managers select specific words/phrases to use for content on their websites (e.g., if a website has a page called “Careers”, but most of their end users search for it using the phrase “Jobs”, intents can be used recommend the website add content containing the word “jobs” to their Careers page). In another example, intents can be used to associate other site search-related features with specific webpages and website content (e.g., another site search-related feature can be returning banners with specific search queries, but intents can be used to associate banners with specific intents that encompass multiple different search queries, which can simplify the association of banners to search queries).

Some search queries can be appropriate for different verticals, which means synonyms to those search queries or words used in the search queries can prove misleading. For example, a search query “apple” can relate to a food vertical and also a technology product vertical. If an analytics system only considers dictionary-based synonyms to the word “apple” (e.g, “produce,” “fruit,” “food,” “groceries”), then the intent bucket associated with “apple” can be inaccurate, thereby missing the users' intent (e.g., some users can search “apple” but intend to find APPLE products). The described analytics systems can avoid these inaccuracies by creating contextually-based intent groupings that include site search queries with similar intents relative to the context of the website. For example, if users search for “apple,” “technology,” “phone,” and the like on a website and frequently select the same webpage(s) from the site search results for these queries, then analytics system can identify these words as being contextual synonyms (e.g., although the words are not linguistic synonyms, they relate to each other because they pertain to and represent a user intent for the same content) to be grouped as part of the same user intent for the website. These words/search queries can be placed in an intent bucket that relates to technology products (e.g., APPLE products) rather than food. By identifying contextual synonyms based on the context of one or more search queries and the corresponding user behavior, the described analytics systems can better determine and more accurately identify user intents for websites. This improvement benefits website administrators who can, for example, continuously improve their websites to reflect user intents and/or diminish user confusion when users perform different search queries.

In some embodiments where user intents are grouped based on different verticals, the analytics system can provide the website administrator, via a user interface module, a “global health score” that depicts how the website compares to other websites available on the World Wide Web. The comparison can relate to a particular vertical that both websites have in common, whether a competing website is successful at catering to a vertical that the administrator's website does not cater to, whether the administrator's website is more successful at catering to a vertical that the competing website also caters to, and/or how the administrator's website can be improved to perform at the same level and/or better than the competing website regarding one or more verticals.

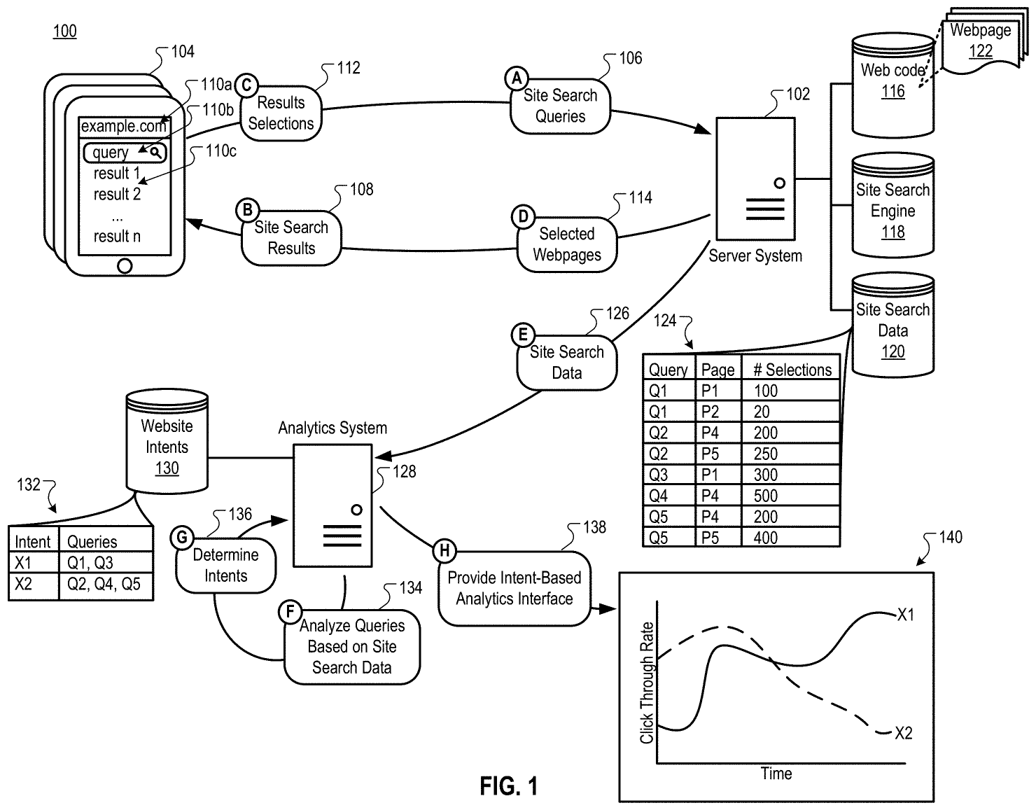

FIG. 1 is an example system 100 for determining user intents on a website. One or more client devices 104 (e.g., mobile devices (e.g., smartphones, tablets, wearable computing devices), desktop computers) communicate with a server system 102 (e.g., cloud) to receive one or more webpages of a website. The server system 102 can be, for example, a web server that is hosting one or more websites. The server system 102 can provide site search services for websites, as well. The webserver component and the site search services of the server system 102 can, in some instances, be provided by separate systems (e.g., first server system hosts the website and second system provides site search service for the website). In some instances, websites can be hosted by a server system other than the server system 102, and site search services for the websites can be provided by the server system 102.

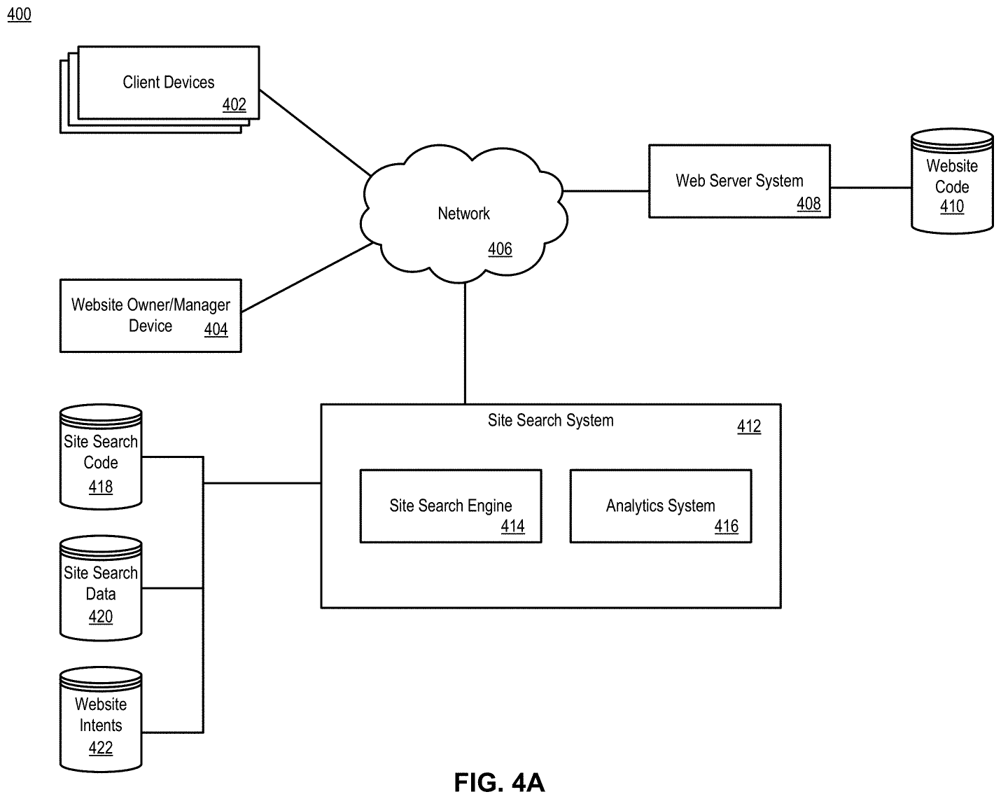

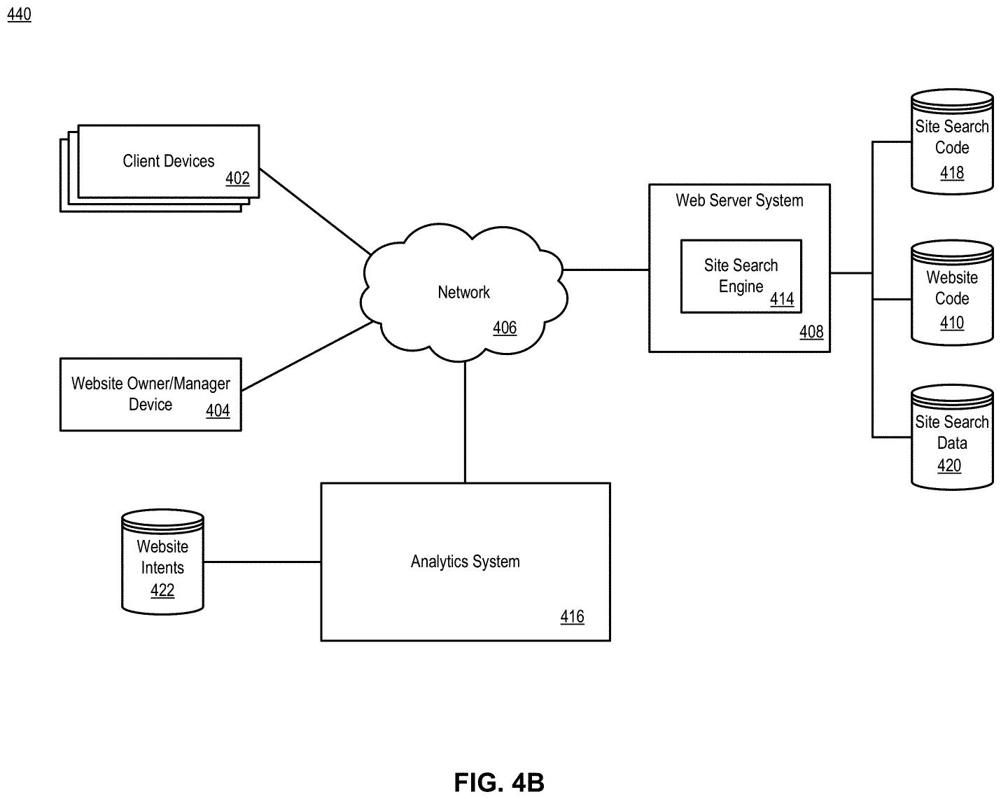

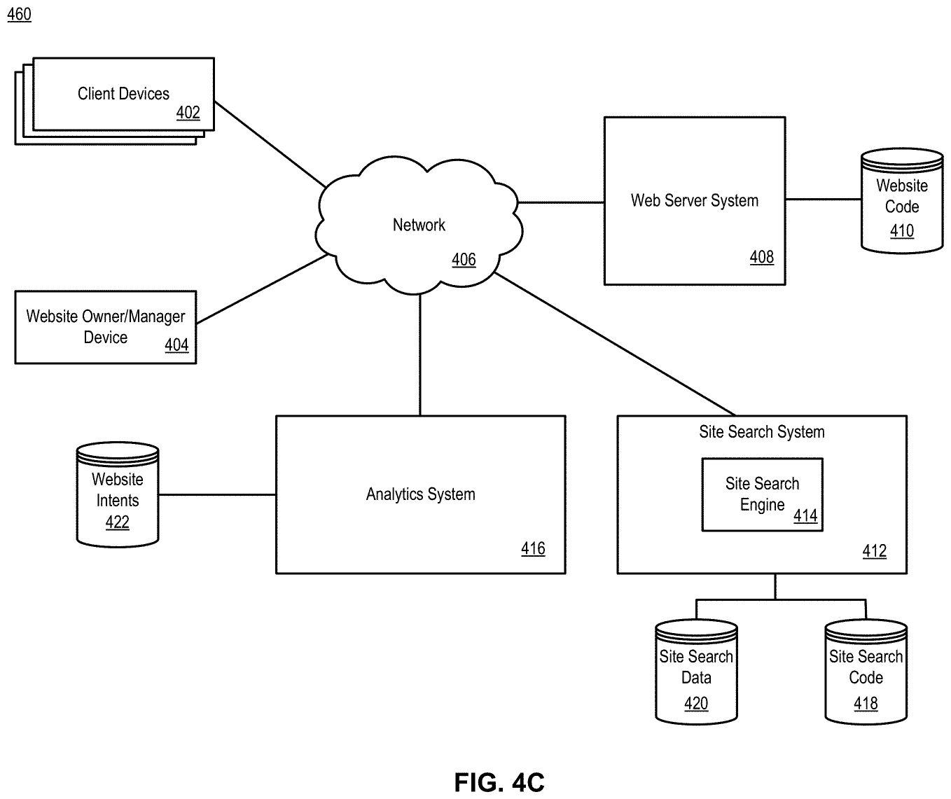

The system 100 also includes an analytics system 128 that determines user intents for the websites hosted by the server system using site search user behavior for the site search services provided by the server system 102. The server system 102 (and/or components) can be part of or separate from the analytics system 128. For example, the site search services can be provided by the same system as the analytics system 128. Other combinations of features provided across different systems are also possible. Example combinations of features provided across different systems are described below with regard to FIGS. 4A-C.

The client devices 104 can request and obtain webpages for a website that has site search services. As depicted in step A (106), the client devices 104 can submit site search queries for the website to the server system 102 via the site search interface provided for the web pages on the client devices 104. The site search interface can be provided on the client devices 104, for example, through web code 116 served by the server system 102, which can include scripts, webpages 122, and other website content (e.g., style sheets, configuration files). As shown in step B (108), the site search query is processed using a site search engine 118 for the website (different websites can have different site search engines) and site search results are provided back to the client devices 104. On the client devices 104, the user is presented with the search results and the user can select a search result, such as a webpage that is most closely related to the user's intent/search query. For instance, an example site search user interface 110a-c is presented, showing the URL for a website being searched (110a), the site search query submitted by the user (110b), and the site search results returned for the query (110c).

The site search results can be selectable and, in response to selection of one or more of the site search results, the client devices 104 can transmit requests for the selected results (e.g., webpages, web resources that are part of the website, portions of webpages) to the server system 102 (step C, 112). For instance, in response to submitting an example site search query for “winter boots” to a website providing an online store, search results can be provided to the client device 104 that include links to webpages for boots, heels, and sandals (e.g., links provided in results 110c). Since the user intends to buy winter boots, the user selects the webpage for boots (e.g., selects the link for the winter boots webpage). Once the user selects a search result/webpage, the client device 104 sends a request to the server system 102 for the webpage associated with the selected result. The server system 102 accesses webpage code associated with the webpage result that the user selected and the server system transmits that webpage to the client device 104 (step D, 114).

The server system 102 can collect and store data from site searches in a site search database 120, which can be used to determine intents for a website based on site search data. For example, the server system 102 can log queries that are submitted by the client devices 104, the results that are selected for the queries by the client devices 104, and/or other relevant site search information (e.g., list of results provided to client computing devices 104 for particular site search queries, indication of whether user stays on web page selected from search result or navigates back to site search results to select another web page, indication of whether user navigates from selected result to other webpages on website). The site search database 120 can store logs of site search data as well as aggregations of such data, including information aggregating a number of selections between queries and webpages that are part of a website. For example, the table 124 depicts example site search data that details the number of times (“# selections) that a particular page (e.g., P1) has been selected by users in response to queries (e.g., Q1) over a period of time (e.g., past week, past month, past year, all time). In some instances, the server system 102 can send information associated with each search query to the analytics system 128 as users search and select search results. The actions that qualify as “selections” can vary, such as users simply selecting webpages from results for site search queries, users dwelling on the selected webpages for a period of time after selection (e.g., users staying on the selected webpage for at least a threshold period of time before navigating to another webpage), users interacting with the selected webpage in some way (e.g., scrolling to view additional content, moving cursor around webpage, selecting elements on webpage, viewing content on webpage based on user engagement tracking techniques), and/or other factors.

For example, looking at the table 124 with example site search data, multiple different devices and users can submit the query Q, which results in 100 selections of page P1 and 20 selections of page P2. This information on the user behavior for site searches for query Q1 as it relates to the contextual website content (e.g., pages P1 and P2) can be used, in combination with site search data for other queries, to determine intents for a website. For example, other queries resulting in similar selections of pages P1 and P2 may be grouped together and identified as an intent for users visiting the website—meaning that it is a topic or content item of interest for users visiting a website that, based on the user selections, appears to be presented on pages P1 and P2 of the website.

The server system 102 can further make site search data from the site search database 120 available to the analytics system 128 for use in determining website intents (step E, 126). For example, the server system 102 can make the site search database 120 available via an API that can be used by the analytics system 128 to query the data, can transmit the data in batches to the analytics system 128, can be part of the analytics system 128 which can readily query and access the site search data 120, and/or other techniques for making data available.

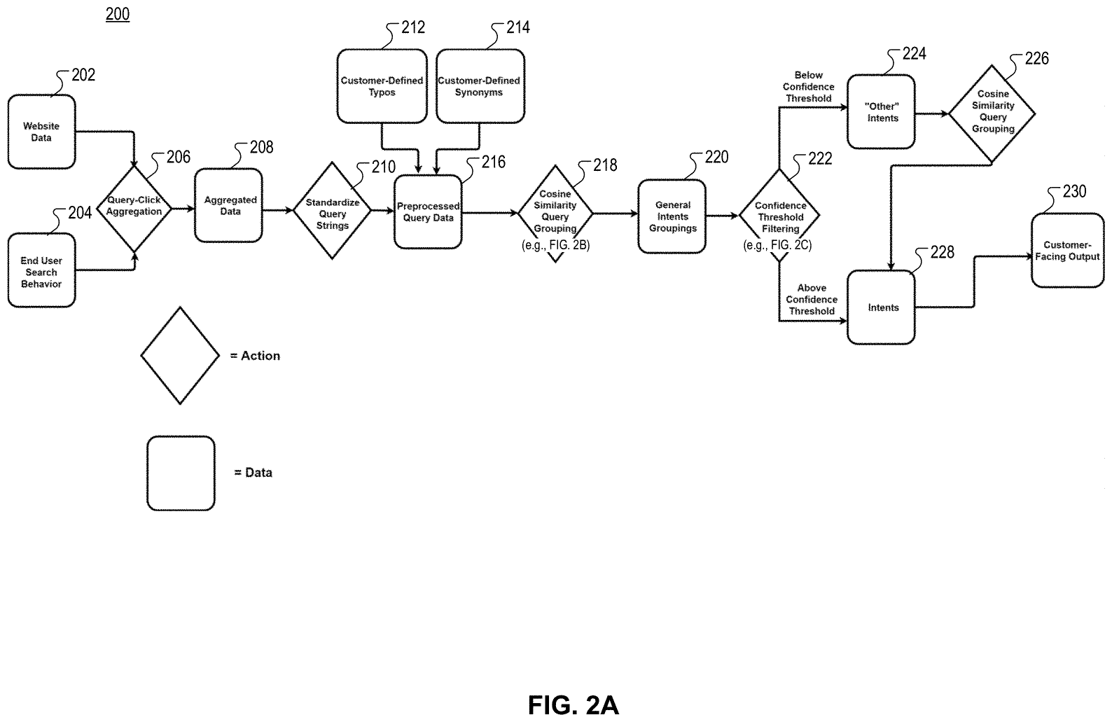

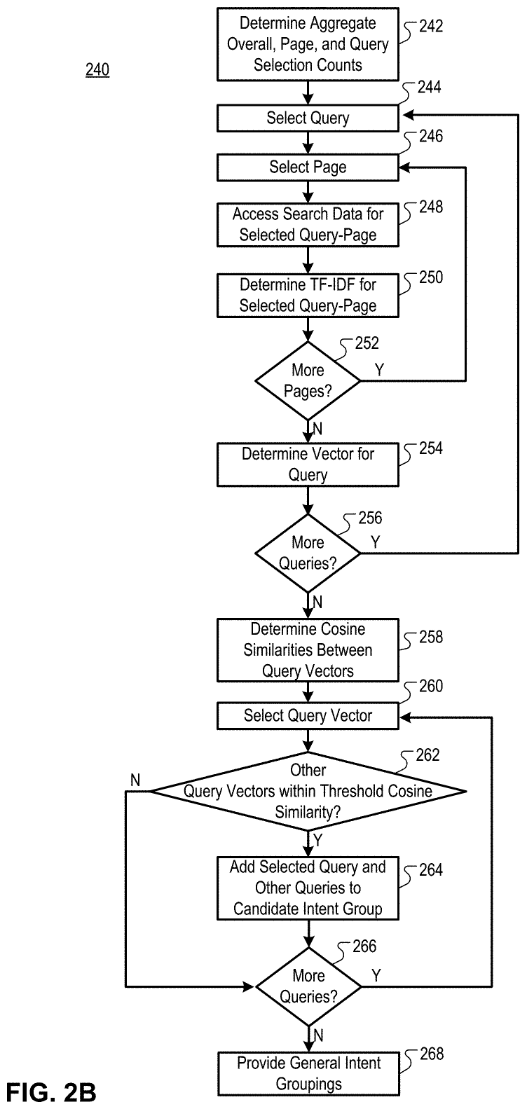

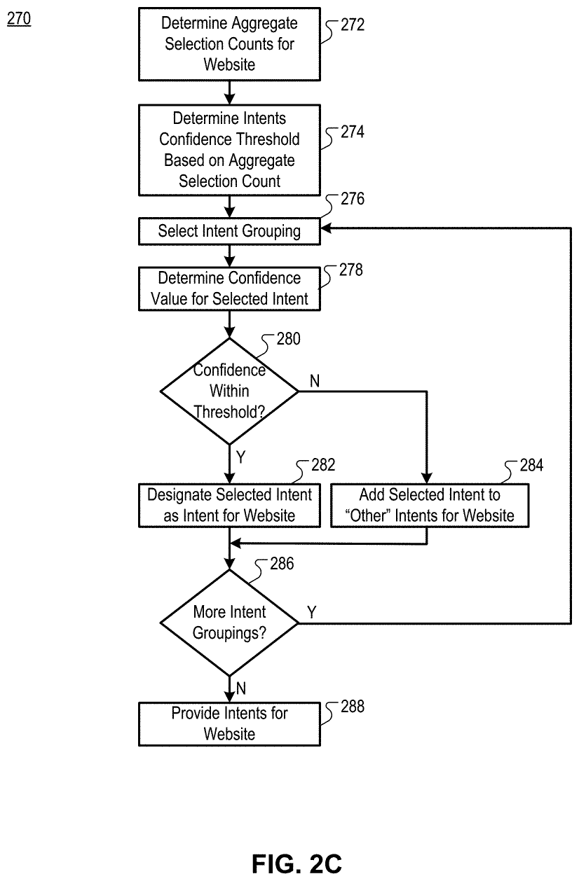

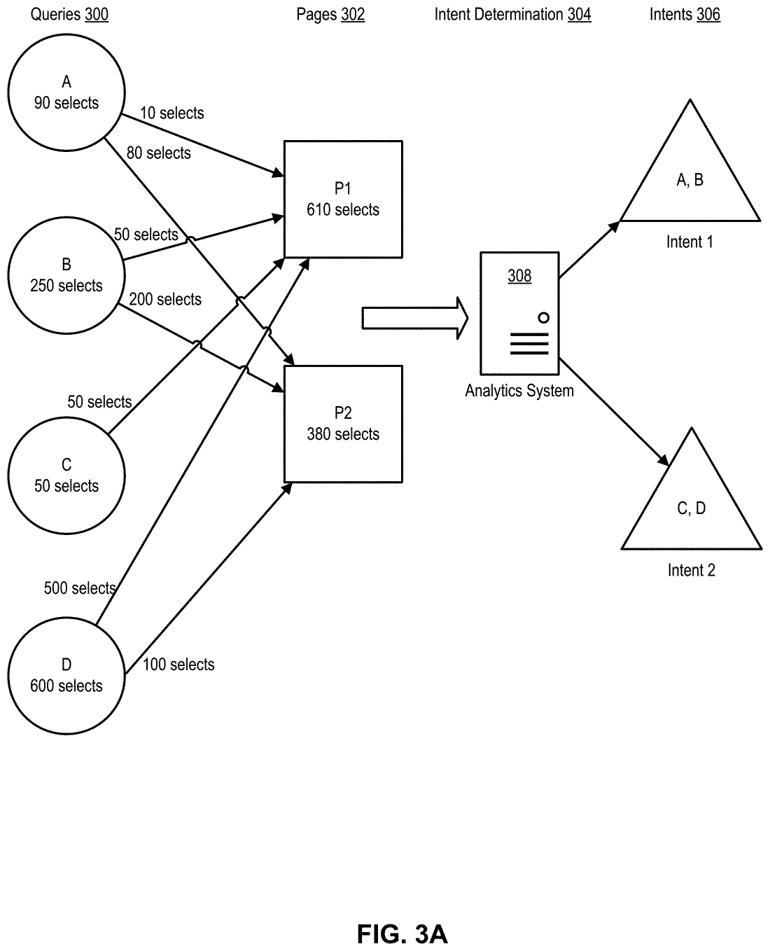

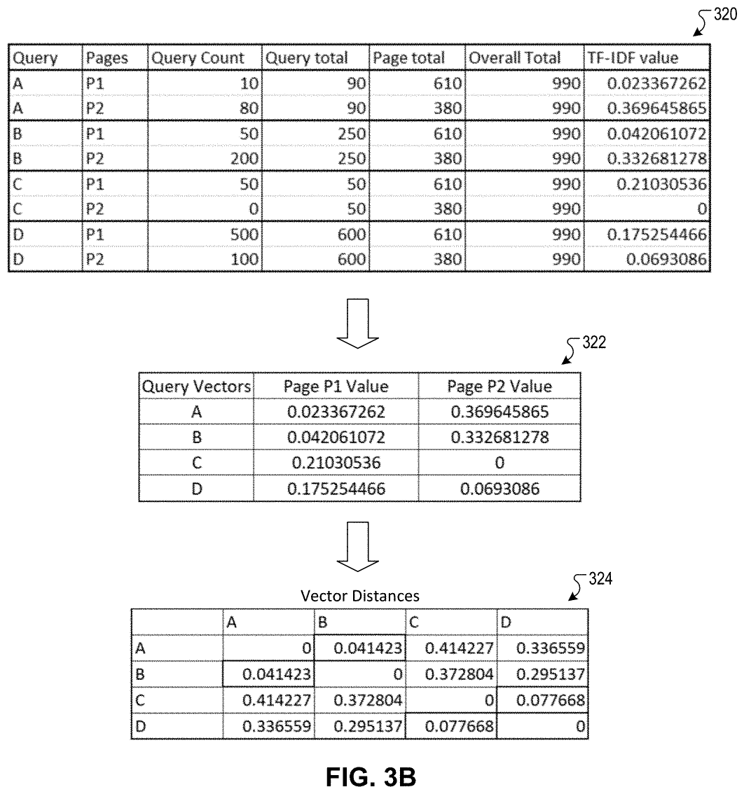

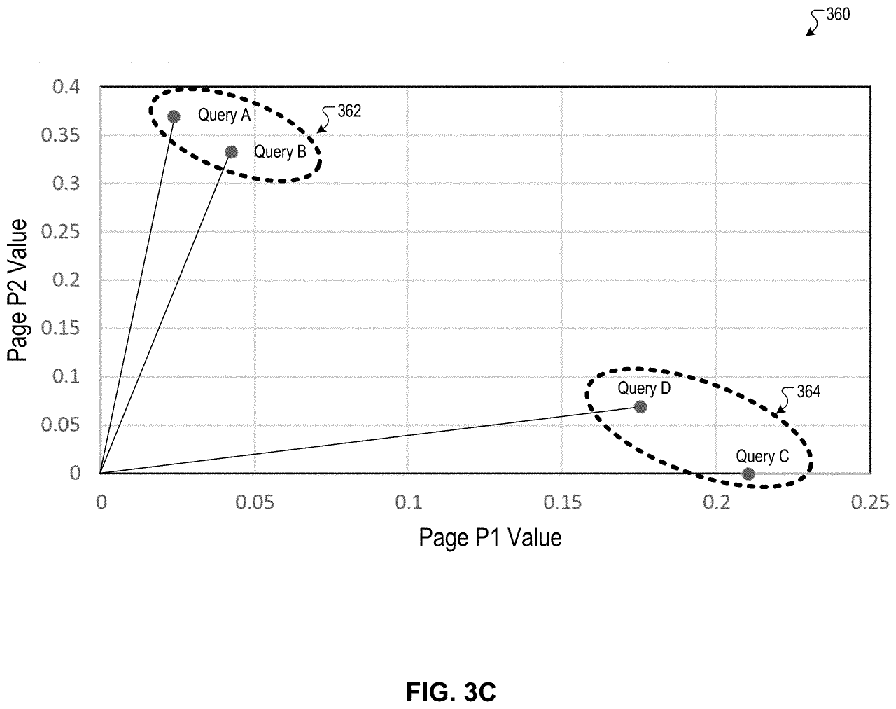

Once the analytics system 128 receives the site search data 120, the analytics system 128 can analyze and initially group the search queries based on the site search data (step F, 134). Any of a variety of appropriate techniques can be used to analyze and initially group queries, such as statistical techniques for identifying the relative importance of queries to webpages based on site search data and then grouping queries together based on that statistical analysis. For example, each of the query-to-page pairs (e.g., pair of query Q1 and page P1, pair of query Q1 and page P2) can be scored based on the significance of the selections of that page for that query relative to selections of that page for other queries, relative to selections of other pages for that query, and/or relative to selections of any page across all queries. For instance, the query-to-page pair Q1-P1 can be scored based on the number of selections for that pair (100 selections), the selections of page P1 across all queries Q1-Q5 (400 selections), the selections of all pages P1-P5 for query Q1 (120 selections), and the overall selections across all pages and queries (1,970 selections). Scoring can be performed across all query-to-page pairs (e.g., pair Q1-P1, pair Q1-P2, pair Q2-P4, etc.). Any of a variety of techniques can be used to determine query-to-page pairs, such as TF-IDF, Latent Dirichlet Allocation (LDA) (e.g., LDA can be used to generate latent topics that the pages share, allowing for grouping of similar pages), Latent Semantic Indexing (LSI) (e.g., LSI can be used to generate latent topics that the pages share, allowing for grouping of similar pages), Hierarchical Dirichlet Process (HDP) (e.g., similar to LDA, but is able to determine the “correct” number of topics present in the documents), Vector Embedding Models (i.e., doc2vec, word2vec, Ida2vec, paragraph2vec, Attention-Based Aspect Extraction) (e.g., models can encode the topics of the pages present in an N-dimensional vector-space, allowing for contextual similarity between pages to be calculated as needed, and used to group similar pages), and/or other appropriate techniques. Example techniques for determining query-to-page scores are described below with regard to FIGS. 2A-C, with an illustrative example provided in FIGS. 3A-C.

The scores for the query-to-page pairs can be combined for each query to generate a composite score the queries, which can be used to initially group queries together into intent buckets. For example, a composite score for the query Q1 can be made of the query-to-page scores for the Q1-page pairs (e.g., Q1-P1 pair, the Q1-P2 pair), such as the composite score being a vector in multi-dimensional space where each dimension corresponds to a different page (e.g., first dimension corresponds to the P1 page score, second dimension corresponds to the P2 page score). The magnitude of each query-to-page score can indicate how closely the content on the corresponding page represents the intent of users who submitted the query. For example, a greater component score for the Q1-P1 pair than for a Q1-P4 pair can indicate that the content on the page P1 more closely represents the intent of the users submitting the Q1 query than the page P4 of the website. The composite score (combined query-to-pair scores) for a query can provide a fingerprint of sorts that represents the comprehensive user intent for the query across the context of content in the webpages for a website.

Intents can be determined from scoring the queries based on the site search user behavior, as indicated by step G (136). For example, queries that have resulting composite scores that are similar to each other can be grouped together and used to identify user intents on the website. For instance, vectors for queries that are located near each other in the multi-dimensional vector space can be grouped together as having similar user intents. Any of a variety of example techniques can be used to group queries based on their composite scores, such as multi-dimensional distance calculations between composite scores, cosine similarity determinations for composite scores, Jaccard similarity, and/or other techniques. Various thresholds can be applied to the comparisons between composite scores to determine whether queries should be grouped together into a common intent bucket, such as distance/similarity thresholds that represent a minimum confidence level that the corresponding queries are sufficiently similar to each other to represent a similar user intent with regard to the website. Thresholds can vary from website to website, including being user defined, and in some instances can be automatically determined/suggested based on an amount of site search data that is available for the website (e.g., websites whether greater amount of site selection data can have higher thresholds for intent determinations than websites with smaller amounts of site selection data). An illustrative example of groupings queries and identifying user intents are described below with regard to FIGS. 3A-C.

In the depicted example in FIG. 1, the queries Q1 and Q3 have similar page selection data (both have selections of page P1) and, as a result, may be determined to be sufficiently similar to each other so as to represent a user intent. Similarly, the queries Q2, Q4, and Q5 have similar page selection data (queries have similar selections of pages P4 and P5) and may be determined to be sufficiently similar to represent another user intent for the website. The analytics system 128 can include a website intents database 130 that stores such intents that are identified for websites. In the depicted example, a table 132 of intents for the website includes two identified intents X1 and X2, which incorporate combinations of the site search queries provided by the site search data 120.

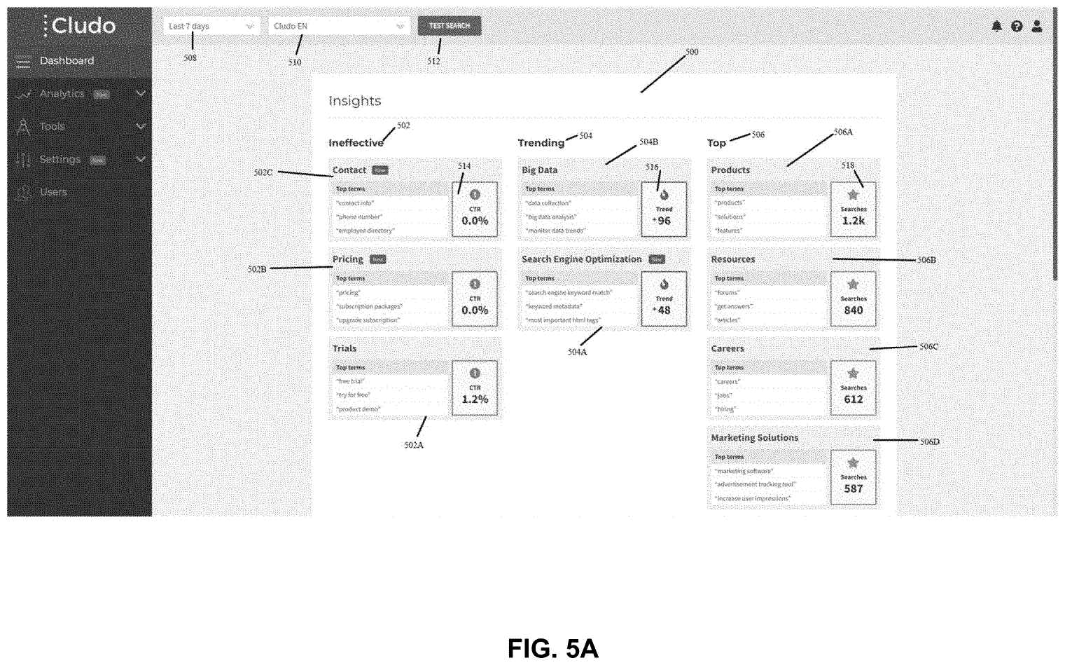

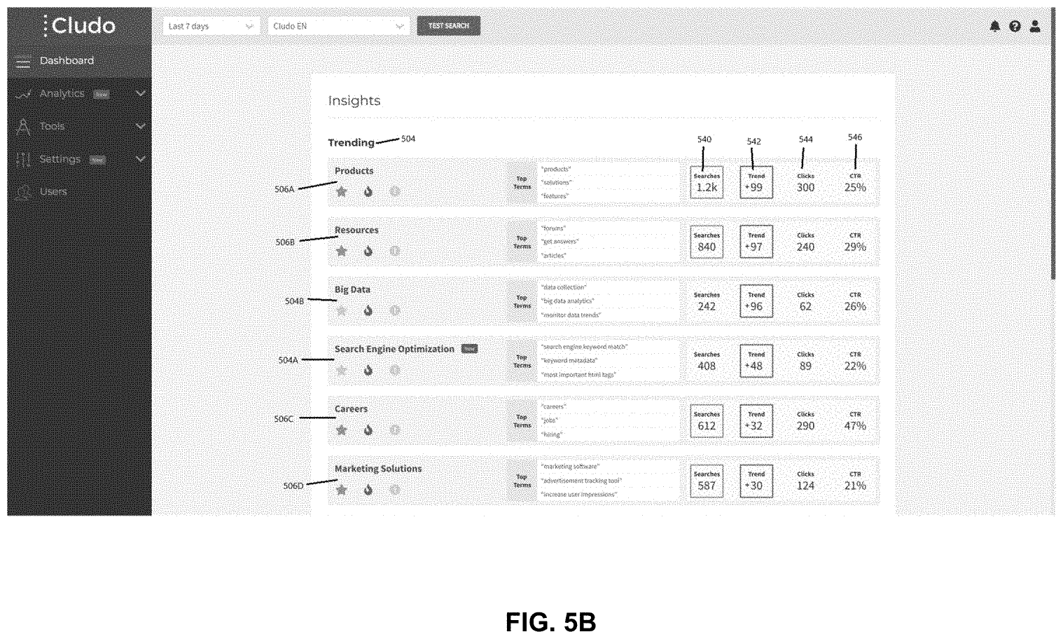

The analytics system 128 can make the website intents data 130 available for any of a variety of uses, such as an analytics interface using the intents to present site search data and/or other website data, an interface to analyze how well the website's content matches up with the intents of users visiting the website, an interface to analyze the organization of the website and its webpages (e.g., menu structures, link structures, page breakout) as they relate to the intents of users visiting the website, and/or other information. As indicated by step H (138), in the depicted example the analytics system 128 provide an intent-based analytics interface 140, which in this example presents the click through rate for site search queries corresponding to intents X1 and X2 over time. The click through rate can correspond to the ratio or percentage of site search queries that are submitted for the intents X1 and X2 that result in the user selecting one of the results that are provided for the queries (as opposed to not selecting the results). The user interface 140 can be presented to a client device that is used by a website administrator or owner. The information can be presented to the website administrator based on smaller and/or simpler sets of variables than, instead, viewing click through data for individual queries. Other interfaces and analytics related to site search queries are also possible, such as total searches, search results relevancy, bounce rate (e.g., how often a user searches for something related to an intent, clicks on a result, but jumps straight back to a new search), site departure rate (e.g., how often a user searches for something related to an intent, then leaves the website entirely), and/or other information. Example intent-based analytics interfaces are described below with regard to FIGS. 5A-B.

As discussed throughout this document, the system 100 can simplify and make data analytics around site search user behavior useful for website owners and managers to improve their websites and to better understand the motivations of users visiting the sites. For example, instead of trying to manually analyze and group search queries into intents, which can be a daunting task in terms of the amount of data to be analyzed and can also result in inaccuracies (e.g., person doing the grouping incorrectly infers the user intent of a search query unrelated to the corresponding site search user behavior), the automated process provided by the analytics system 128 can provide reliable, accurate, and actionable user intent determinations for websites.

Intents and corresponding analytics provided by the analytics system 128 can be used by website owners and managers in any of a variety of ways. For example, the analytics system 128 can assist in identifying intent-based trends for websites. For instance, a website administrator handles a website for a university and can use aggregated analytics information for intents (as opposed to individual search queries) to identify an upward trends of users interested in applying for admission over the past several years. In addition to gaining these insights, the analytics system 128 can further provide website administrator suggestions about how to modify the website to focus more webpages, content, and/or search capabilities on admissions and applications, which is the popular and/or trending user intent. If the website administrator chooses to make one or more of the recommended modifications, the website may improve its user engagement by assisting users in more easily finding and accessing information about applying and/or enrolling in the university.

In another example, the analytics system 128 can present suggestions for curing existing deficiencies on a website to satisfy user intents that appear to not be sufficiently met. For instance, assume a website offers food delivery service and a user places an order on the website. The user waits an hour for the food and the website does not update with an order status. The user may want to contact the food delivery service, but the website does not include readily accessible links and/or webpages for contacting the food deliver service. As a result, the user may try numerous search queries on the website, as well as on a search engine such as GOOGLE or BING, to find contact information. The analytics system 128 can identify and associate the user's search queries with a user intent relating to contact information, and can identify that the website has low performance on that intent (e.g., low click through rate). The analytics system 128 can flag this intent as an area where the website can improve to better meet user needs.

The analytics system 128 may also provide recommendations about how to improve the website, such as adding pages, menus, and/or links to relevant content that will be better surfaced in response to user queries with such intents. The analytics system 128 can further provide suggested modifications based on how other websites meet the same or similar user intents. For example, if a another food delivery service includes a phone number on the same webpage as the order status and most end users search for phone numbers and have the most ease communicating when the phone number is on the same webpage as the order status, then the analytics system can determine that a similar modification to the website can be effective.

The analytics system 128 can additionally recommend and/or automatically apply modifications to the site search engine 118 for the webpage to more accurately return relevant content for particular user intents that are represented by particular site search queries. For example, if the example intent X1 is determined to have a strong correlation to page P1, the analytics system 128 can update and/or modify the site search engine 118 for the website to include the page P1 in the search results (and/or rank the page P1 at or near the top of the site search results) in response to site search queries Q1 and Q3 that represent the intent X1.

FIGS. 2A-C are flowcharts of example techniques 200, 240, and 270 for determining user intents for a website based on site search user behavior data. The example techniques 200, 240, and 270 can be performed by any of a variety of systems, such as the analytics system 128, the server system 102, and/or other devices and/or systems.

Referring to FIG. 2A, the example technique 200 determines user intents 228 for a website based, at least in part, on website data 202 and end user search behavior 204 for the website. The technique 200 includes aggregating query-click data (206) from the website data 202 and the end user search behavior 204. The website data 202 can include, for example, data identifying webpages that make up a website, information describing the content of these webpages, and/or the webpages themselves. The end user search behavior 204 can include, for example, information identifying site search queries for the website as well as site search user behavior identifying actions (or inactions) users performed in response to receiving site search results (e.g., select webpage from results for site search query). The click-query aggregation (206) can result in aggregated data 208 that identifies, at least, site search queries and corresponding aggregated user behavior for the site search queries (e.g., number of selections of each page for each query).

The aggregated data 208 can be standardized (210), which can involve, for example, removing punctuation, stop words, and/or other characters/strings from the site search queries in the aggregated data 208. Stop words include common words that, in terms of search engines and computer processing, do not provide valuable insight into user intents. Examples of common stop words include, but is not limited to: a, and, of, so, and the. As part of standardizing the aggregated data (210), site search queries that end up being the same as other site search queries after performing the standardization process can be combined with the other site search queries in the aggregated data. For example, the site search query “crock-pot” can be standardized to “crockpot” (remove ‘-’ punctuation) and can be combined with another site search query “crockpot” in the aggregated data 208.

Once the site search queries are standardized, customer-defined typos 212 and customer-defined synonyms 214 can be used to further process the aggregated data to generate preprocessed query data 216. The customer-defined typos 212 can include misspellings and/or other common typographical errors that are mapped to correctly spelled site search queries, and the aggregated data for misspelled site search queries can be combined with the correct spelled site search queries. For example, customer-defined typos 212 can map misspellings “crockput” and “crokpot” to the site search query “crockpot.” The customer-defined synonyms 214 can include information that identifies linguistic synonyms, contextual synonyms, and/or descriptive words that group queries together as representing, more or less, the same search query. For example, synonyms and/or descriptive words for the site search query “crockpot” can include “slow-cooker,” “electric cooker,” “food cooker,” and “cooking pot.” As with the customer-defined typos 212, the customer-defined synonyms 214 can be used to combine the site search queries and their corresponding data that are mapped together. The query standardization (210), the customer-defined typos 212, and the customer-defined synonyms 214 can be used to simplify the site search data and to ensure that the data for what amounts to more or less the same queries (e.g., synonyms, misspellings, typographical errors) is combined for the intents analysis.

Various techniques can be use the preprocessed query data 216 to generate general intent groupings 220. For example, a combination of techniques can be used, such as combining a first technique to identify or weigh the strength of associations between each of the site search queries and the webpages that are part of the website can be used to generate vectors assessing the site search queries within the context of the website, and a second technique can be used to group the site search queries based on these vectors. Any of a variety of appropriate techniques can be used for the first technique, such as TF-IDF and/or other appropriate techniques. Similarly, any of a variety of appropriate techniques can be used for the second technique, such as cosine similarity and/or other techniques for determining distances between vectors in multi-dimensional space.

For example, TF-IDF function, or term frequency-inverse document frequency, can be used to determine the significance of relationships between search queries and webpages that are part of the website based on which webpages one or more end users select after receiving search results relating to one or more search queries. TF-IDF can use the selection frequency for search queries with webpages in the website as the metric for evaluating the significance of query to webpage relationships. The term frequency (TF) part of the technique can assess how frequently a particular webpage was selected for a particular query relative to how many selections were made, across all webpages, for that same query. The inverse document frequency (IDF) part of the technique can assess how many selections of the particular webpage occurred (across all queries) relative to the selections all webpages (across all queries). The site search queries can be evaluated with regard to TF-IDF across each of the webpages (or across each of the webpages with at least a threshold number of webpage selections), and those values can be combined to generate a comprehensive assessment of the site search query within the context of the website. For instance, the values can be combined for a site search query to effectively provide a vector that represents the site search query within a multi-dimensional space that corresponds to the webpages of a website.

For example, using a simplified example of queries with corresponding vectors mapped within a two-dimensional space (an x-y plane), if the two queries are similar, as described above, vectors representing each search query will be near each other within the two-dimensional space (e.g., same or similar trajectory within two-dimensional space, same or similar component values for two-dimensional space). The more dissimilar the search queries are, the more likely the vectors representing the search queries will diverge, creating a bigger angle between the two vectors. By taking the cosine of the angle, the similarity between the two search queries can be determined and represented by a value. For example, the closer the resulting value is to 1, or the bigger the cosine value, the more similarity exists between the two search queries. On the other hand, the closer the value is to 0, or the smaller the cosine value, the less similarity exists between the two search queries. The purpose of using cosine similarity is to more accurately group search queries into intent buckets based on similarity of search queries within the context of the webpages that are part of the website. FIG. 2B provides an example technique for determining query similarity groupings (218).

The general intent groupings 220 that are generated can be evaluated against confidence threshold groupings (222) to determine intents 228. For example, the distances/similarity determinations can be evaluated against one or more thresholds to determine whether that grouping of site search queries is sufficiently close to constitute being designated as an intent 228. The thresholds can be automatically and/or manually determined, such as being based on the volume of site search queries and selections for a website (e.g., greater number of site search queries received and selections performed can cause threshold value for intent grouping to be increased). Website owners may be able to modify and/or adjust the threshold values for intent groupings manually, and may be permitted to compare the resulting intent groupings for different threshold values to determine which threshold value to use for the website. An example technique for determining confidence threshold filtering is described below with regard to FIG. 2C.

General intent groupings 220 that are less than the confidence threshold (222) can be placed into a catchall or “other” intent grouping 224 for queries that are not sufficiently similar to other queries within the context of a website to constitute a separate intent. The “other” intents bucket contains one or more site search queries that are not sufficiently related to an intent 228 to be grouped with that intent. A determination (226) can be made as to whether any of the search queries in the “other” intent 224 should be associated with a previously-defined intents 228 and/or a new intent bucket/group created out of the queries in the “other” intents 224. The determination (226) can use a similarity grouping technique that is similar to the techniques 218 and 222 described above. The determination may use relaxed or varied thresholds over what is used in the techniques 218 and 222, in some instances.

Once the intents 228 have been generated, including extracting intents from the “other” intents 224, a user facing output 230 can be provided to a website owner or manager (or other user). The user facing output 230 can include, for example, a user interface to view intent-based analytics for the website and/or to view intent-based suggestions/recommendations for improvements to the website so that it can include content that more closely aligns with user intents. Intents can also be used to modify and/or update a site search engine for the website. Other intent-based outputs and uses are also possible. Example user interfaces with intent-based information is described below with regard to FIGS. 5A-B.

FIG. 2B is a flowchart of an example technique 240 for determining general intent groupings based on site search user behavior data. The example technique 240 can be performed by any of a variety of systems, such as the analytics system 128, the server system 102, and/or other devices and/or systems. The example technique 240 can be performed as part of the technique 200, for example, at step 218. FIGS. 3A-C will be discussed in combination with the discussion of the technique 240. FIGS. 3A-C provide a simple illustrative example of determining intent groupings based on site search user behavior using the techniques described throughout this document, including the technique 240.

Referring to FIG. 3A, the illustrative example involves example site search queries 300 (queries A-D) that resulted in selections of webpages 302 (pages P1-P2) form the search results for those queries. The number of selections between each query 300 and each page 302 is indicated by an arrow from the query to the page along with a number of selection. The absence of an arrow between a query and a page indicates that there were no selections of that page for the query. The values within each of the queries 300 indicates a total number of selections for that query across all pages. The value within each of the pages 302 indicates a total number of selections of that page across all of the queries 300. To keep the example simple, the website here contains two pages (P1 and P2) and four example queries (A-D). The site search queries 300 for the website and the selections among the queries 300 and the pages 302 can be provided to an analytics system 308 for intent determinations 304, which can produce the intents 306, which in this example include two intents—Intent 1 with queries A and B, and Intent 2 with queries C and D. This data will be referenced in the discussion of the techniques 240 and 270 below.

Referring back to FIG. 2B, aggregate selection counts can be determined across query-page pairs, queries, pages, and overall (242). For example, the site search data may be provided as query logs with information identifying individual query instances along with user actions in response to those queries. Such query logs (and/or other site search data) can be aggregated. This aggregated information can be combined to determine the number of selections for each query-page pair (e.g., 10 selections for the pair of query A and page P1, 80 selections for the pair of query A and page P2), each query (e.g., 90 page selections resulting from query A), each page (e.g., 610 selections of page P1), and the overall number of selections for all queries across the website (e.g., 990 selections across all queries and pages).

The technique 240 can then proceed to determine a TF-IDF score for each query-page pair by selecting a query (244), selecting a page (246), accessing the search data for the selected query page (248), and then determining a TF-IDF score for the selected query-page (250). The TF-IDF score for a query-page pair can be determined using the following example equation:

Score(Qₓ−P_{y})=Ct.(Qₓ−P_{y})/Ct.(Qₓ−Pₐₗₗ))*log(Ct.(Qₐₗₗ−Pₐₗₗ)/Ct.(Qₐₗₗ−P_{y}))

where Score (Qₓ−P_{y}) is the TF-IDF score for the pair of query Qₓ band page P_{y}, Ct.(Qₓ−P_{y}) is the number of selections of page P_{y} for query Qₓ, Ct.(Qₓ−Pₐₗₗ) is the number of selections for the query Qₓ across all pages, Ct.(Qₐₗₗ−Pₐₗₗ) is the number of selections across all queries and all pages, and Ct.(Qₐₗₗ−P_{y}) is the number of selections of the page P_{y} across all queries.

Referring to FIG. 3B, an example determination of TF-IDF scores for each of the query and page pairs depicted in FIG. 3A is presented in table using the above equation. In this example, the column “query count” corresponds to Ct.(Qₓ−P_{y}), the column “query total” corresponds to Ct.(Qₓ−Pₐₗₗ), the column “page total” corresponds to Ct.(Qₐₗₗ−P_{y}), and the “overall total” column corresponds to Ct.(Qₐₗₗ−Pₐₗₗ). The resulting TF-IDF scores for each query-page pair is presented in the “TF-IDF value” column. For example, the TF-IDF value for the query A and page P1 is determined to be 0.02 whereas the TF-IDF value for query A and Page P2 is determined to be 0.37. The greater the TF-IDF value, the greater the association/relationship between the query and the webpage.

Referring back to FIG. 2B, the TF-IDF score determinations (250) can be repeated across all pages (252) for the selected query (244). Once all of the TF-IDF scores for a query have been determined, a vector for the selected query can be determined (254). The vector can represent the query within the context of the webpages that make up the website. For example, referring to FIG. 3B, the table 322 provides an example of the vectors that are determined for the queries. Each query A-D has its own vector, which has component values for each page P1 and P2. For example, the query A has a resulting vector with a page P1 value of 0.02 and a page P2 value of 0.37. Each dimension of the vector space can correspond to a different page of the website.

Referring back to FIG. 2B, the steps 244-254 can be performed for each query (256). Once all of the query vectors have been determined, cosine similarities between the query vectors can be determined (258). For example, the cosine similarity can be determined using the following equation:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} ,$$

where, given two vectors A and B, the cosine similarity, cos(θ), is represented using a dot product and magnitude of those two vectors based on the vector components Aᵢ and Bᵢ. The resulting similarity ranges from −1 meaning exactly opposite, to 1 meaning exactly the same, with 0 indicating orthogonality or decorrelation, while in-between values indicate intermediate similarity or dissimilarity.

Other techniques for determining similarity and dissimilarity between the vectors are also possible, such as taking the distance between the vectors. For example, referring to FIG. 3B, the table 324 presents distance determinations between the vectors representing the queries A-D in the context of the website. The greater the distance value in this table 324, the less similar, and the lesser the distance value, the more similar two queries are to each other.

Referring back to FIG. 2B, the steps 260-268 can be performed to determine the general intent groupings based on the query vectors. A first query vector is selected (260) and then a determination is made as to whether other query vectors are within a threshold cosine similarity to the selected query vector (262). If another query is, then the selected query and the one or more other queries within the threshold cosine similarity to each other are added to a candidate intent grouping (264). The process can continue by evaluating each of the query vectors (266). After evaluating all of the query vectors, the resulting general intent groupings can be provided (268). For example, referring to FIG. 3B and table 324, the query vector A can be selected and a determination can be made as to whether the similarity values with the other queries are within a threshold value. In this example, the queries A and B are similar, as indicated by a lower value (0.04), and the query pair A and C and the query pair A and D have larger values (0.41 and 0.34, respectively), indicating that they are less similar to each other. Depending on the threshold, the queries A and B may be added to an initial general intent grouping. The process can then be repeated for each of queries B, C, and D, with intent groupings being identified whenever similarity values are within a threshold value for being added to an intent grouping.

FIG. 2C is a flowchart of an example technique 270 for determining intents based threshold confidence level evaluations for general intent groupings. The example technique 270 can be performed by any of a variety of systems, such as the analytics system 128, the server system 102, and/or other devices and/or systems. The example technique 270 can be performed as part of the technique 200, for example, at step 222. FIGS. 3A-C will be discussed in combination with the discussion of the technique 270.

The technique 270 can involve automatically determining confidence thresholds for a website (272-274) and then applying those thresholds to general intent groupings (276-288). The confidence thresholds can be based on any of a variety of factors, such as the aggregate number of selections for a website (272), which can be used to determine intent confidence thresholds (274). As discussed above, a greater number of aggregate selections for a website may increase confidence thresholds—meaning that a higher level of confidence is required in order for an intent grouping to be identified—as opposed to a smaller number of aggregate selections, which may lower confidence thresholds.

An intent grouping can be selected (276) and a confidence value for the selected intent grouping can be determined (278). For example, the confidence value can correspond to a degree of similarity between the query vectors that are included in the selected intent grouping, such as a cosine similarity value, a distance value, and/or other determinations. When more than two queries are included in a general intent grouping, the confidence value can be determined based on a degree of similarity among the query vectors, such as a mean or median value can be used. If the determined confidence value is within the confidence threshold (280), then the intent grouping can be designated as an intent for the website (282), otherwise the intent grouping may be added to the “other” intents for the website (284). The technique can repeat for each of the intent groupings (286), and the resulting intents for the website can be provided (288). Additionally and/or alternatively, other confidence thresholds can also be used, such as thresholds based on aggregating the number of unique searches for an intent and comparing that to the total number of unique searches a search engine has received for that intent. Such an example confidence threshold can identify low-value intents with a low search volume and can move them into the “other intent” grouping. For example, if an intent only represents a fraction of a percent of an engines total unique searches, then a determination can be made that it doesn't add value to the output and its constituent queries for that intent can be moved into the “other” group.

Referring to FIG. 3C, an example graph 360 is depicted showing two intent groupings 362 and 364 that are generated based on comparisons of the vectors for queries A-D. For instance, in this example, the confidence threshold could be determined to be a distance value of 0.10—meaning that intent groupings with an average distance among the query vectors in the intent grouping that are 0.10 or less can be identified as intents for the website. In this example, a first intent 362 can be identified for queries A and B, which have a distance of 0.04 in table 324, and a second intent 364 can be identified for queries C and D, which have a distance of 0.07 in table 324.

FIGS. 4A-C present different system arrangements of the analytics system 416 being implemented with regard to a web server system 408 and a site search system 412. The systems depicted in FIGS. 4A-C can be used to implement any and all of the techniques, systems, and devices described above with regard to FIGS. 1-3.

Referring to FIG. 4A, a first example system arrangement 400 is depicted in which the analytics system 416 is implemented as part of a site search system 412, which is separate from the web server system 408. In this arrangement 400, client devices 402 transmit requests for websites over a network 406 (e.g., internet, mobile data network, local area network, wireless network) to the web server system 408, which retrieves the requested website code 410 and transmits it back to the client devices 402 for interpretation. This website code 410 can, either directly or by incorporating scripts/other code 418 from the site search system 412 that is presented as part of the website, cause site searches to be transmitted to the site search system 412. The site search system 412 can receive site search queries and, using a site search engine 414 for the website, can identify relevant results and transit them to the client devices 402 for presentation. Selection of those results can be transmitted back to the site search system 412 and stored along with the site search queries as part of the site search data 420. The analytics system 416 can use the site search data 420 to determine website intents 422 for the website hosted by the web server system 408, and can present website intent-related information and user interfaces for presentation to the website owner/manager device 404.

Referring to FIG. 4B, the depicted example arrangement 440 includes the same components as the arrangement 400, but they are arranged in a different way. In this arrangement 440, the site search engine 414 is implemented as part of and hosted by the web server system 408, which causes the web server system 408 to manage the site search code 418 and the site search data 420. The analytics system 416 can generate intents 422 by accessing and/or being provided with the site search data 420 from the web server system 408.

Referring to FIG. 4C, the depicted example arrangement 460 includes the same components as the arrangements 400 and 440, but they are also arranged in a different way. In this arrangement 460, the analytics system 416 is separate from the site search system 412, which are both separate from the web server system 408. In this instance, the site search system 412 makes available and/or provides the site search data 420 to the analytics system 416 for determining the website intents 422.

Other implementations and arrangements are also possible beyond those depicted in FIGS. 4A-C.

FIGS. 5A-B are example user interfaces presented to a website administrator. The example user interfaces can be provided by or as part of any of the systems, techniques, or other features described throughout this documents, such as being provided by the analytics system 128, the analytics system 308, the analytics system 416, and/or other systems, and/or as being provided as part of the user interface 140 and/or the customer-facing output 230.

FIG. 5A depicts an example dashboard user interface of insights 500. The insights 500 presents information about each of the webpages and/or intents generated for a website. In this example, there are three categories: Ineffective 502, Trending 504, and Top 506. The Ineffective 502 category includes one or more generated intents that have a significant number of searches, but low click-through rate. The Trending 504 category includes one or more generated intents that are becoming more popular on the website. In other words, more end users can be searching for the intents that are listed under the Trending 504 category. The Top 506 category includes one or more generated intents that are the most popular intents searched on the website.

In this example, the Ineffective 502 category includes a Trials intent 502A, a Pricing intent 502B, and a Contact intent 502C. The intents 502A-C can represent the least effective searched terms by end users that are associated with the website (e.g., search queries with a high volume but low user engagement, as demonstrated by a low click-through rate). Each of the intents 502A-C includes a list of top 3 terms used in one or more search queries on the website by end users. Each of the intents 502A-C also includes a score 514, which represents a click-through-rate (CTR). The click-through-rate indicates a ratio of users who click on a search result link to a number of total users who view a webpage associated with the search result link. For example, the Trials intent 502A includes the top terms “free trial,” “try for free,” and “product demo.” When these terms are used by end users in search queries on the website, 1.2% represents a ratio of end users that click on a search result to a total number of users who view the associated webpage under the Trials intent 502A.

In this example, the Trending 504 category includes a Search Engine Optimization intent 504A and a Big Data intent 504B. The intents 504A-B can represent one or more categories/topics/intents that end users are searching for more often on the website and/or categories/topics/intents that end users are selecting more often as a search result. Each of the intents 504A-B includes a list of top 3 terms used in one or more search queries on the website. Each of the intents 504A-B also includes a score 516. The score 516 represents a numeric value of points that indicates how much one or more intents 504A-B is trending. In some embodiments, the score 516 can be on a scale of +1 to +100, where +1 indicates a smallest amount of trending/popularity and +100 represents a largest amount of trending/popularity. In this example, the Big Data intent 504B is trending more and/or is more popular than the Search Engine Optimization intent 504A because the Big Data intent 504B has a score of +96 whereas the Search Engine Optimization intent 504A has a score of +48. The Trending 504 category can rank one or more intents based on the score 516, such that the intents that are trending the most (e.g., have a score closer to +100) are placed at the top of the list of intents and the intents that are trending the least are placed lower on the list of intents. In other embodiments, the score 516 can be represented on a different scale and/or with a different set of values (e.g., percentages).

In this example, the Top 506 category includes a Products intent 506A, a Resources intent 506B, a Careers intent 506C, and a Marketing Solutions intent 506D. The intents 506A-D can represent one or more categories/topics/intents that end users are searching for the most on the website and/or categories/topics/intents that end users are selecting the most as a search result. Each of the intents 506A-D includes a list of top 3 terms used in one or more search queries on the website. Each of the intents 506A-D can also include a score 518. The score 518 represents a numeric value of points that indicates how many searches and/or search queries occurred on the website relating to each of the intents 506A-D.

In some embodiments, a threshold value can be set to represent the minimum number of searches required for an associated intent to be ranked as one of the top intents in the Top 506 category. For example, in this embodiment, the minimum threshold value can be set to 500 searches, and any generated intent with 500 or more searches as the score 518 can be ranked from most searches to least searches under the Top 506 category. In this example, the Products intent 506A is the most popular intent searched for by end users. The Products intent 506A has 1,200 searches as the score 518. The Marketing Solutions intent 506D, on the other hand, is the least popular top intent searched for by end users as it has 587 searches. As mentioned, one or more other generated intents can exist but are not listed in the Top 506 category because those generated intents do not reach a minimum threshold value (e.g., 500 searches).

In some embodiments, an intent listed under the Trending 504 category can also be listed under the Top 506 category. For example, if an intent is trending and has a trending score of +100, it can also have the most number of searches or at least reach the minimum threshold value of searches to be included in the Top 506 category. In addition, the website administrator can adjust the minimum threshold value manually. The minimum threshold value can also adjust automatically and/or in real-time, based on factors including but not limited to how popular the website is, how many end users use the website, how many end users search on the website, how many search queries are performed on the website, how many intents are generated for the website, etc.

The dashboard user interface also includes a drop-down option 508. The website administrator can select to view the insights 500 over a defined length of time from the drop-down option 508. In this example, the website administrator selected to view the insights 500 over the last 7 days. In other embodiments, the website administrator can select to the view the insights 500 over one day, a week, a month, a year, etc. The insights 500 will reflect one or more changes to one or more intents listed in the Ineffective 502 category, the Trending 504 category, and the Top 506 category. For example, if the website administrator selects to view the insights 500 over the course of a month, the Top 506 category can include one or more less intents and/or one or more different intents. Each of the intents listed under the Top 506 category can further include different values for the score 518.

In the embodiment in FIG. 5A, the Search Engine Optimization intent 504A, the Content intent 502C, and the Pricing intent 502B all include a label “New.” These intents have a label “New” because they have recently been associated with the Trending 504 category or the Ineffective 502 category in the last 7 days. Based on the time period the administrator selects in the drop-down option 508, a “New” label can appear and/or disappear next to one or more differently categorized intents.

The dashboard user interface further includes a website option 510, from which the website administrator can select one or more different websites. The insights 500 will reflect information pertaining to the website selected from the website option 510. In this example, the website administrator selected the Cludo English website from the website option 510. In another embodiment, the administrator can select the same Cludo website which appears in a different language. In yet another embodiment, the administrator can select a different website in a same language and/or in a different language.

The dashboard user interface also includes a Test Search button 512. Upon selecting the button 512, the insights 500 will update to reflect the time frame selection from the drop-down option 508 and the website selection from the website option 510.

FIG. 5B depicts an example user interface when the website administrator clicks on an intents category. In this example, the administrator clicked on the Trending 504 category. The Trending 504 category includes one or more generated intents from FIG. 5A: the Products intent 506A, the Resources intent 506B, the Big Data intent 504B, the Search Engine Optimization intent 504A, the Careers intent 506C, and the Marketing Solutions intent 506D. In this example, the intents are ranked based on a trend value 542 associated with each intent. A searches value 540, a clicks value 544, and a CTR value 546 are also displayed on this user interface. In other examples, the intents can be ranked based on one or more of the values listed. For example, if the website administrator selects the Top 506 category in FIG. 5A, FIG. 5B can represent the Top 506 category and the intents associated with this category can be ranked based on the searches value 540.

Each of the intents listed in FIG. 5B include an indication of whether the intent appears in the Top 506 category, the Trending 504 category, or the Ineffective 502 category of FIG. 5A. In some embodiments, one or more intents can appear in one or more categories. Each intent listed can also include an indication of whether the intent is “New” over the last 7 days or whatever time period the administrator selects from the drop-down option 508 in FIG. 5A. Each intent further lists top 3 search terms used by end users. Each intent includes the searches value 540, which indicates how many searches were performed by end users associated with that intent, the trend value 542, which indicates on a scale of +1 to +100 how popular/trending the associated intent is, the clicks value 544, which indicates how many clicks end users make on a search result associated with that intent, and the CTR value 546, which indicates a percentage of end users that click through a search result versus total users viewing a webpage associated with the intent. As previously mentioned, the intents listed in FIG. 5B can also be ranked based on any of the searches value 540, the trend value 542, the clicks value 544, or the CTR value 546. The “Ineffective” Intents 502 can also be ranked based on a weighted CTR calculation, which presents information that can highlight Intents that are both Ineffective (low CTR) and have a significant amount of searches. For example, an Intent with a CTR of 5% and 100 searches is less “Ineffective” than an Intent with a CTR of 7% 10,000 searches.

In other embodiments, the analytics system described throughout this disclosure can identify, create, and/or determine possible search queries and/or user intents that can be associated with each webpage of a website. Natural language processing (e.g., NLP) techniques can be used to identify one or more topics on each webpage of the website. Search queries can then be grouped to each of those topics, based on historic user behavior data. For example, the analytics system can analyze how many times one or more users searched and/or clicked on a particular webpage and/or content, what search queries were used in the past, and/or what are the most commonly used search queries on the website. In other embodiments, one major topic can be identified for a webpage and a hierarchy of additional topics, or sub-topics, can be created for that webpage. For example, if the website is an online store and one webpage is for “Women's Clothing,” the major topic of the webpage can be “Women's Clothing” and the hierarchy of sub-topics can include “Dresses,” “Tops,” “Jackets,” “Jeans,” and “Pants” (all of which may or may not lead a user to a new webpage associated with each sub-topic). Once the hierarchy of topics for each webpage is identified, the analytics system can identify potential user intents for using the website and each of the webpages. The analytics system can generate one or more possible search queries that can lead a user to each webpage as well as to particular items, products, and/or information on each webpage. These search queries and intents can be modified automatically and over time as one or more users perform different search queries on the website.

The analytics system can further generate one or more synonyms, descriptive words, and/or contextual-based words that represent the user behavior and/or search queries for a topic in the hierarchy of topics. The generated search queries can be based off these terms that the analytics system identifies. Determining possible search queries that can lead a user to each webpage can also be vertical-specific. In other words, if one webpage of a website pertains to technology products and another webpage pertains to shipping information, the technology vertical and the shipping vertical will have different generated search queries. These verticals do not overlap in search queries so users are not confused or misled when using the website. Vertical-specific search query generation is beneficial to meet user intents.

Once the analytics system determines and/or generates potential search queries to identify each webpage of the website, the model can filter out any noise and/or random search queries that are not useful to meet the user intents. For example, user-defined search queries that are accessed from historic user data and have not resulted or related to any content available on the website can be filtered out. If, for example, a website offers news articles and a user constantly searches for news relating to toy manufacturing and the website never returns results relating to toy manufacturing, then the user-defined search queries relating to toy manufacturing can be removed. Other search queries may be filtered out because the search queries consist mostly of stop words, words irrelevant to the hierarchy of topics for each webpage of the website, etc.

Over time, the analytics system can determine whether particular intents, topics, words, and/or search queries should be stored and used by the analytics system or whether particular intents, topics, words, and/or search queries should be timeboxed. The system can determine whether to keep particular intents and/or search queries that are trending at the moment and/or will be trending in the future, based on user behavior, how competitors or related websites change to accommodate user intents, and/or how the website changes to accommodate user intents.

Over time, intents and/or topics do not radically change, so groupings of intents do not need to be timeboxed. For example, if the website is an online clothing store and each webpage is associated with a different type of clothing, the existing webpages are not going to suddenly be associated with food/grocery products. One or more content on each webpage can change, which means a performance of the intents associated with the webpage can be modified over time (e.g., the performance of the intents can be timeboxed), but the actual intents and/or topics of each webpage can mostly remain constant. For example, if the online clothing store has a webpage for selling jewelry and the store launches a new product of watches, then the intent of the webpage remains the same but the original performance, which was specific to necklaces, rings, earrings, and bracelets, can be modified to include watches. This is an example where the performance of the intent is not necessarily timeboxed but it is modified to accommodate for a new product that is under the umbrella intent and/or topic of the webpage: jewelry.

Various implementations of the systems and techniques described here can be realized in a digital electronic circuity, integrated circuitry, specially designs ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” and “computer-readable medium” refer to any computer program, product, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network can communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for determining user intents for a website, the method comprising:
accessing, by an analytics system, site search data for the website, wherein the website includes a plurality of webpages, wherein the site search data includes (i) site search queries transmitted by client devices to a site search engine for the website and (ii) site search user behavior that identifies particular webpages from among the plurality of webpages selected on the client devices from among search results for the site search queries;
determining, by the analytics system, query-page scores for each pair of the site search queries and the plurality of webpages based on the site search data, wherein each of the query-page scores identifies how well a webpage represents a user intent for a site search query;
generating, by the analytics system, combined scores for the site search queries based on the query-page scores, wherein each of the combined scores for a site search query combines the query-page scores for that site search query;
identifying, by the analytics system, groupings of the site search queries based on the combined scores;
determining, by the analytics system, user intents for the website based on the groupings of the site search queries; and
outputting, by the analytics system, the determined user intents.

2. The method of claim 1, wherein:
the query-page scores comprise term frequency inverse document frequency (TF-IDF) scores that are determined for each pair of the site search queries and the plurality of webpages based on the site search data, and
the site search data comprises a number of selections for the plurality of webpages for the site search queries.

3. The method of claim 2, wherein, for each of the query-page pairs that pairs a particular site search query and a particular webpage, the TF-IDF score is determined based on (i) a first number of selections of the particular webpage for the particular site search query, (ii) a second number of selections of the particular webpage across all of the site search queries, (iii) a third number of selections of all of the plurality of webpages across all of the site search queries, and (iv) a fourth number of selections of all of the plurality of webpages for the particular site search query.

4. The method of claim 3, wherein, for each of the query-page pairs that pairs a particular site search query and a particular webpage, the TF-IDF score is determined from a term frequency score and an inverse document frequency score,
wherein the term frequency score is determined by dividing the first number of selections by the second number of selections,
wherein the inverse document frequency score is determined by taking a log of the third number of selections divided by the fourth number of selections, and
wherein the TF-IDF score is a product of the term frequency score and the inverse document frequency score.

5. The method of claim 1, wherein the combined scores for the site search queries comprise multi-dimensional vectors for each of the site search queries, where each dimension corresponds to one of the plurality of webpages for the website.

6. The method of claim 5, wherein the multi-dimensional vectors map the site search queries into a multi-dimensional space that represents a context provided by the plurality of webpages for the website, with the positioning of the site search queries in the multi-dimensional space representing associations between the site search queries and the context provided by the plurality of webpages for the website.

7. The method of claim 6, wherein the groupings are identified based on the proximity of the site search queries to each other within the multi-dimensional space using the multi-dimensional vectors representing the site search queries.

8. The method of claim 7, wherein the proximity is determined using cosine similarity determinations among pairs of the site search queries.

9. The method of claim 7, wherein the proximity is determined using distance determinations among pairs of the site search queries.

10. The method of claim 7, wherein the groupings are identified based on sets of the site search queries being determined to have at least a threshold level of proximity to each other within the multi-dimensional space.

11. The method of claim 1, wherein determining the user intents comprises:
determining a confidence value for the groupings; and
identifying the groupings that have at least a threshold confidence value as user intents for the website.

12. The method of claim 11, wherein the confidence value is determined based on how closely related the site search queries within the groupings are to each other.

13. The method of claim 12, wherein:
the combined scores for the site search queries comprise multi-dimensional vectors for each of the site search queries,
each dimension corresponds to one of the plurality of webpages for the website,
the multi-dimensional vectors map the site search queries into a multi-dimensional space that represents a context provided by the plurality of webpages for the website, with the positioning of the site search queries in the multi-dimensional space representing associations between the site search queries and the context provided by the plurality of webpages for the website, and
the closeness of relationships between the site search queries is determined based on distances among the multi-dimensional vectors to each other within the multi-dimensional space.

14. The method of claim 11, wherein the confidence value is determined based on a number of site search queries for the groupings relative to an overall number of site search queries for the website.

15. The method of claim 11, wherein the threshold confidence value is determined based on an overall number of site search queries for the website.

16. The method of claim 1, wherein outputting the user intents comprises outputting site search analytics for the website that are grouped based on the user intents.

17. The method of claim 16, wherein the site search analytics includes one or more of the following: a number of search queries for the user intents, a click-through-rate for the user intents, and a trending identifier for the user intents.

18. The method of claim 16, wherein outputting the site search analytics comprises:
identifying one or more ineffective user intents that comprise user intents with at least a threshold number of search queries and click-through-rates below a threshold click-through-rate,
outputting one or more graphical elements in a user interface identifying the ineffective user intents.

19. The method of claim 16, wherein outputting the site search analytics comprises:
identifying one or more trending user intents that comprise user intents with at least a threshold increase in a number of search queries over a period of time,
outputting one or more graphical elements in a user interface identifying the trending user intents.

20. The method of claim 16, wherein outputting the site search analytics comprises:
identifying one or more top user intents that comprise user intents with at least a threshold ranking among the user intents based on or more of: a number of searches, a number of clicks, and a click-through rate,
outputting one or more graphical elements in a user interface identifying the top user intents.
